(19) United States
(12) Patent Application Publication
(10) Pub. No.: US 2010/0038564 A1
(43) Pub. Date: Feb. 18, 2010

(54) MICRO-ACTUATOR DEVICE FOR THE USE IN A BIOCHIP OR BIOSYSTEM

(75) Inventors: Murray Fulton Gillies, Eindhoven (NL); Jacob Marinus Jan Den Toonder, Eindhoven (NL); Mark Thomas Johnson, Eindhoven (NL); Marc Wilhelmus Gijsbert Ponjee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/441,547

(22) PCT Filed: Sep. 19, 2007
(86) PCT No.: PCT/IB2007/053796

§ 371 Date: Mar. 17, 2009

(30) Foreign Application Priority Data
Sep. 20, 2006 (EP) 06120933.4

(51) Int. Cl. F16K 31/64

(52) U.S. Cl. 251/11

(57) ABSTRACT

The Invention concerns to a micro-actuator device for the use in biochip or bio-system. In order to achieve a micro-actuator device for the use as a micro pump in biosensors or bio-systems, or at least bio-chips, by which the actuation can be steered very precisely and effective, the solution is that the micro actuator consist of a photosensitive actuator element (1), which can be deformed from a reversal basic-form into an activated deformation form by photonic activation of a light source (3, 4, L1, L2) in order to generate with this controlled movement a defined flow in a gas or a liquid.

The invention relates to a micro-actuator device for the use in a biochip or biosystem.

Various actuation mechanisms have been developed and are used. One example is disclosed in the US 2004124384 A1, where an electrostatic deformable thin film as an actuation element is shown and described. This actuation element is used as an opening and closing element of a micro valve.

Micro actuator structures can either be used to create local mixing of fluids or, with the correct drive pulses, a lateral transport of the liquid. If a large number of structures are to be controlled individually then preferably an active matrix is used to drive the large number of independent micro actuators.

Biochips for biochemical or biochemical analysis, such as molecular diagnostics, will become an important tool for a variety of medical, forensic and food applications. Such biochips incorporate a variety of laboratory steps in one desktop machine.

In almost all of the protocols that one wishes to carry out with a lab-on-a-chip system the transportation of fluid and in particular the bio-particles within that fluid, is crucial.

There is a variety of transportation methods available for the actuation of the bio-fluid. These include electrical actuation, ((di)electrophoresis and electroosmosis), capillary movement, pressure driving via MEMS (Micro ElectroMechanical), thermal gradients and so on.

So it is an object of the present invention to achieve a micro-actuator device for the use as a micro pump in biosensors or biosystems, or at least bio-chips, by which the actuation can be steered very precisely and effective.

So the solution is, that the micro actuator consists of a photosensitive element, which can be deformed from a reversal basic-form into an activated deformation form by photonic activation from a light source in order to generate with this controlled movement a defined flow in a gas or a liquid.

So the stated object is achieved for a micro actuator device for the use in biosensors by the features of patent claim 1.

Further embodiments of this system or device are characterized in the dependant claims 2-15.

The basic idea and function of the invention is, that the actuators are stimulated optically, that means by photons.

In the present invention it is proposed to use photosensitive actuator elements which will be deformed by light stimulation. This is realized by liquid crystal molecules undergoing a reversible conformation change under the influence of illumination with light.

A first embodiment of the invention is that the dynamic parameters of the generated movement are influenced by steering the photonic energy input to the photosensitive element by an illumination device. This will be realized by diverse means, described as follows.

An embodiment of this is that the photosensitive element is constituted in that way, that the reversal basic form or ground form is an at least partially curled strip, and the deformed form is an at least flattened form of the strip. So the sequence of movement can cause a flux in a liquid or a gas.

In a further embodiment a 2-dimensional matrix array of photosensitive actuator element is arranged on a 2-dimensional photonic processing array of light sources, in which each single light illumination source can be steered independently from each other, in order to be able to activate each single photosensitive actuator element.

In an advantageous embodiment the material of the photosensitive actuator element is a liquid-crystal-elastomer LCE.

An easy way of light source for activation is a light emitting diode, and in case of a photonic processing area it is an array of light emitting diodes. In this sense it is advantageous to use as light sources, or the light sources respectively organic light emitting diode(s) OLEDs. These diodes can be easily arranged as a 2-dimensional array, as an activation array for the array of actuators folded on them.

In a further embodiment light shutter means are arranged between the light sources and the photosensitive actuators. By this a pattern of activation in the array can be easily generated in a defined an predetermined way.

In one embodiment the light shutter means comprise substantially but not exclusively of a liquid crystal device, by which areas of no light transmission can easily be switched on or off, in order to steer the amount of light energy to the photosensitive actuator.

Other alternatives are possible. So a further embodiment is that between the photosensitive actuator element and the light source secondary polymer-MEMs actuators as light shutters are arranged, which can be activated by heat or electrostatic. The function in detail is described further on.

In order to generate a defined pattern of activation the light shutter means are arranged as passive matrix array, or as active matrix array. Both cases are possible and described further on.

In a further embodiment the light source is a scanning laser beam. This is a very special but possible and under special conditions a very advantageous construction. While it is suggested either a passive matrix LCD or OLED any other passive matrix device could be used. Rather than using an integrated light source it is also possible to use any other light source that can be locally modulated. This can for example be a passive matrix array of inorganic light emitting diodes or alternatively a scanning laser beam.

In a further embodiment two light sources are arranged, one on each side of the actuator in order to control or feedback of the mechanical function of the actuator by camera CCD (charge coupled device) array or by photodiode array.

In a further embodiment a special form of electronic circuit is applied that the circuit to steer the actuator array has integrated a photodiode (L1) as a current source whose current depends on the intensity of an incident light source, by which the optical feedback of the actuator is caused.

Furthermore, in an embodiment two switches are arranged in the circuit in order to switch between the light source (L1) for photonic actuation of the actuator and the light source (L2) for the optical feedback of the position or actuation of the actuators.

Detailed embodiment are displayed in the drawings and described in the following.

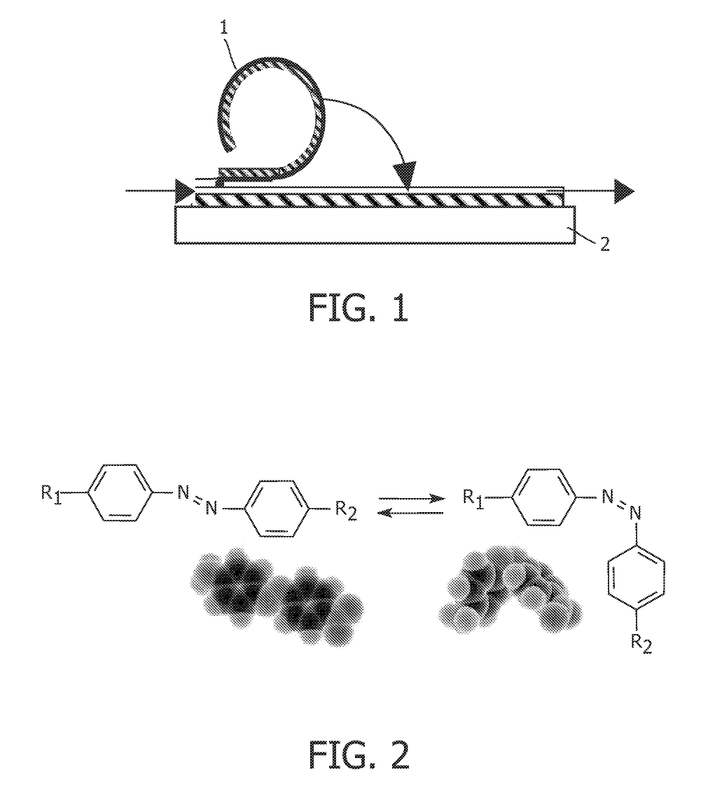

Different embodiments of the invention are shown in FIG. 1 to FIG. 6.

FIG. 1 shows a principle of a rollable optically controlled LCE (Liquid-Crystal-Elastomer)

FIG. 2 shows a LCE molecules mechanism

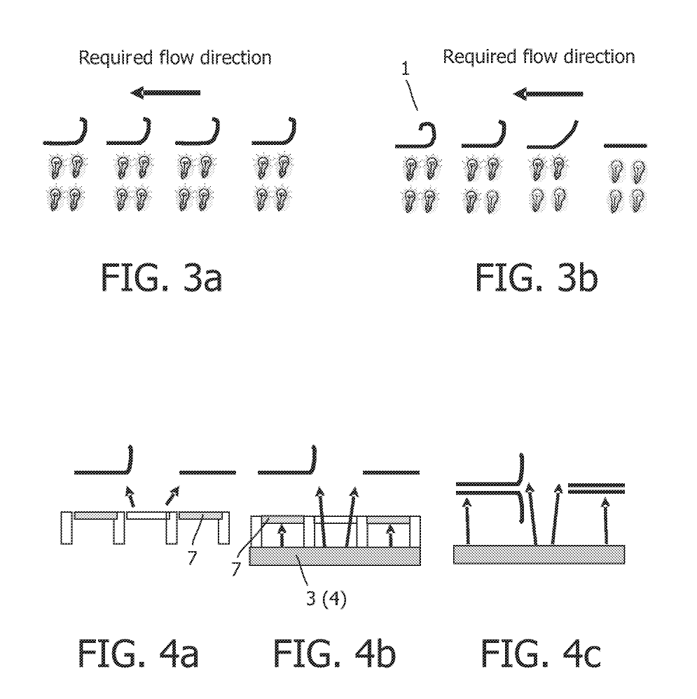

FIG. 3 shows a controlled illumination

FIG. 4 shows examples for photonic LCE addressing

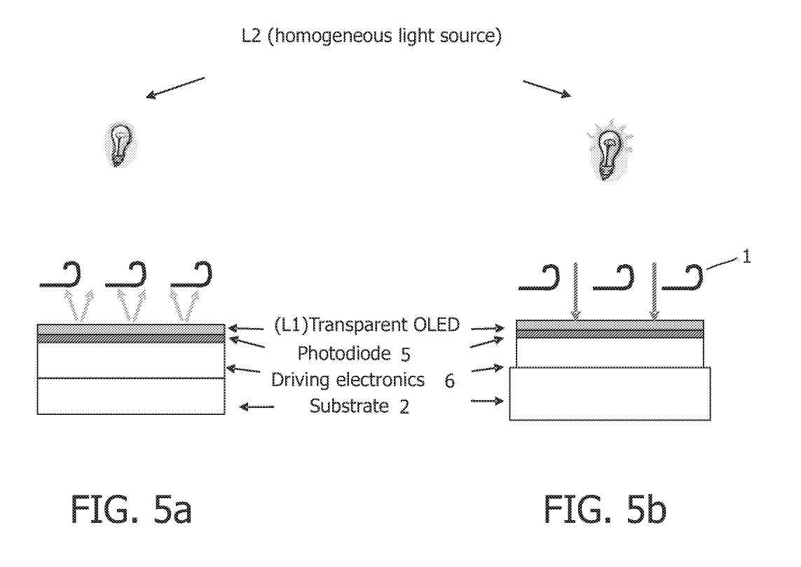

FIG. 5 shows an LCE with integrated photo-diode

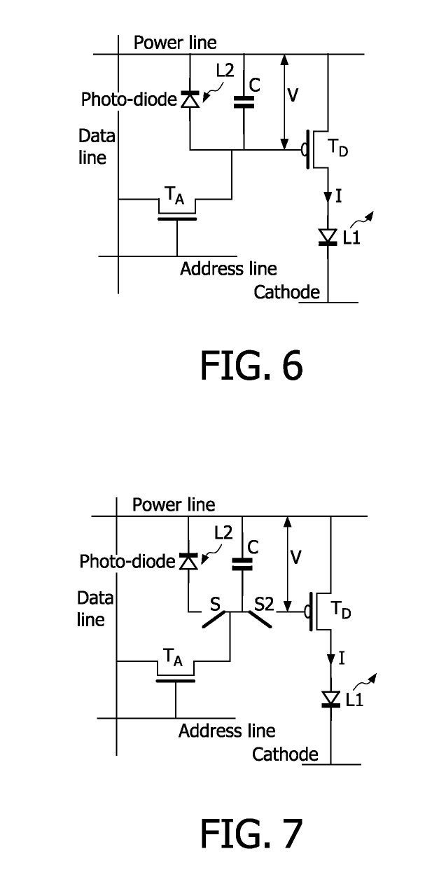

FIG. 6 shows an electronic circuit for optical feedback

FIG. 7 shows an alternative to FIG. 6

FIG. 1 shows the structure of the photosensitive actuator element 1. These structures can be seen in schematic cross-section in FIG. 1. The structure normally consists of an under-electrode covered by an acrylate film, and a second acrylate film also covered with an electrode. This for the case, when the actuator is stimulated by an electrostatic force. The second acrylate film is structured and freed from the substrate by photo-lithography and sacrificial layer etching. Upon applying a voltage difference between the two electrodes, the upper film can overcome the force caused by internal stress and un-roll. When the voltage is removed the film rolls-up again to its original position. The structures can be between 15 and 100 μm in length. FIG. 1 shows a micrograph of such a film in the rolled up state. The structures can be actuated at frequencies of 20-30 Hz, even in the presence of a fluid. It has been shown that such structures can be used to mix fluids efficiently. A problem with electrostatic actuation is that electrolysis may occur. The voltages needed to drive the actuator depend on its design but typically these are tens of volts. Due to the fact that the electrodes are in direct contact with the fluid, which is usually water for biological applications, this results in gas generation. In order to overcome this problem other methods have been suggested such as photonic actuation. For photonic actuation there have been developed materials, based on Liquid Crystal Elastomeric networks. The Liquid Crystal Molecules, in this case, contain azo-benzene groups that undergo isomerization under the influence of illumination by light. That is, the molecules change from a straight conformation to a kinked conformation. The light source for optical actuation of the actuator 1 therefore can be arranged in the substrate 2 or on the substrate 2 or even on top of this construction, that means adjacent to the photosensitive actuator or actuation element 1.

Different arrangement and positions of the light source are shown in further figures.

FIG. 2 shows a Liquid Crystal molecule undergoing a reversible conformation change under the influence of illumination with light. By controlling the initial orientation of the LC molecules and subsequent cross-linking in an elastomeric network, one obtains a material that deforms globally when illuminated with light, e.g. by bending. The effect is reversible when illuminating with light of a different wavelength. In order to use this activation mechanism effectively it is necessary to modulate the light locally. While light actuation of polymer structures is interesting for pumping bio-medical fluids in a lab-on-a-chip it is only possible if the light can be locally modulated. For example, if there are lines and columns of LCE (Liquid Crystal Elastomers) structures with an homogenous illumination then only mixing, rather than flow, could occur. The structures should be driven in such a way so as to create a delayed rolling up along the same axis at which fluid actuation is required.

A time or phase delay between different areas of LCE structures in rolling up can be achieved by illumination with a spatially variable illumination source. The difference in the reaction of the LCEs to homogeneous illumination and variable illumination is illustrated schematically in FIG. 3, especially in the FIGS. 3 (a) and (b). The illumination of the photosensitive actuation element 1 can be varied in the spatial dimensions in either, one direction along the axis of required movement or in 2 dimensions, if this is necessary to induce a certain flow pattern. Either the intensity of the light pulse or the duration of the light pulse or the spectral distribution of the light pulse can be varied along the required direction of flow.

Creating such a variable illumination requires the integration of individually controllable light sources into the substrate.

By this invention is suggested to use a passive matrix light source in order to scan over the area that has to be addressed. A passive matrix device makes use of a threshold voltage so that only at the crossing point of a line and a column there can be sufficient voltage to activate the light source. While it may be possible to address individual LCE structures it is more likely that they will be addressed in groups. Such a passive matrix light source 3 could for example be emissive such as an OLED 4 (organic light emitting diode), FIG. 4, especially in FIG. 4(a). The advantages of using an OLED as a light source are

light is only generated at the location necessary for actuation (low power),

thin film encapsulation allows for the light source to be placed directly under the area to be actuated (no parallax),

OLEDs can deliver high peak light intensities which may be necessary for photonic modulation of LCE structures.

A shuttered light source, that means the use of a light shutter 7 above the light source 3, 4 such as an LCD, FIG. 4(b), could be used to actuate the photonic LCEs. An LCD uses a layer of liquid crystal to locally block a homogeneous light source placed behind the device. This has the advantage of being able to have two or more light sources and via multiplexing the LCEs can either be selected or deselected in the relevant time frames. A disadvantage is that there is always a glass layer between the LCD and the LCEs which may cause parallax.

An alternative embodiment is shown in FIG. 4 (c), which is perhaps more elegant than a passive matrix LCD or OLED. This is to actuate the photonic LCEs with a secondary PMA (PolyMEMS actuator) structure which can be addressed electrostatically (e.g. using a passive or active matrix), FIG. 4(c). In this embodiment is made use of the fact that the rolling up of an electrostatic PMA has a voltage threshold. By placing an electrostatic PMA beneath a photonic structure one can use it to locally block a homogeneous light source and in this way transfer an optical pattern to the photonic LCE. By doing this one in fact retains electrostatic addressing of the sample but avoid electrical contact with the liquid and hence electrolysis. The advantage of such a structure is that there is little parallax and as for LCD two light sources can be used.

While it is suggested either a passive matrix LCD or OLED any other passive matrix device could be used. Rather than using an integrated light source it is also possible to use any other light source that can be locally modulated. This can for example be a passive matrix array of inorganic light emitting diodes or alternatively a scanning laser beam.

With a described passive matrix it is generally only possible to address one line at a time. For example if there are 100 lines then an addressable group of LCE structures will only be exposed to the light source for 1% of the time. To be able to compensate for this the light source has to be able to produce 100 times more light in this short period of time as compared to the light source when running continuously. To be able to avoid this, because as such a high light dose is usually detrimental to both the light source itself and the biological sample, an active matrix should be employed. This also reduces the number of connections as compared to a passive matrix and offers more flexibility in circuit design. In the most simple embodiment a standard active matrix based display can be situated behind the photonic LCE structure and used for actuation. The active matrix can be used to drive light sources or light shutter such as LC, OLED, FED or inorganic LEDs.

While the placing of a commercially available unit such as a TFT-LCD behind the LCE structures is certainly attractive as there will be little development costs the unit could be improved in order to drive LCEs. In particular optical feedback could be employed in order to sense if the LCEs structures have indeed responded to the generated light source. This signal could simply be monitored to check that the LCEs are responding as required to the light source or alternatively, if partially roll-out structures are required, the signal could be used for optical feedback. In order to implement optical feedback a photodiode 5 may be integrated into the active matrix backplane or a camera (e.g. CCD) positioned behind the active matrix backplane may be used. In the latter case an imaging system may be present between the active matrix backplane and the camera. The light incident on the photodiode 5 or camera will be a measure of how open the LCE structures are. For the case of an OLED where the light emitting layer can be made transparent then the photodiode should be placed under the local light source L1 (3), see FIG. 5. By placing a homogenous light source L2 on the other side of the LCEs the intensity of this source, as measured by the photodiode, can be used as a signal for the fraction of the LCEs structures which are open. Both the intensity and wavelength of L2 are chosen so as not to cause actuation of the LCEs. To allow this measurement either light source L1 should be switched off during the sampling period or the wavelength of L1 should be chosen so as not to perturb the signal on the photo-diode 5 from L2. In practice the switching off of L1 will probably be necessary during the measurement.

Instead of using the homogeneous light source L2 only for measuring feedback it may be used for multiple purposes. For example with the correct wavelength it may be possible to use the light at a weak intensity for generating a measurement signal of how open the LCEs are, i.e. the grade of rolling/unrolling of the LCEs, and at higher intensity for erasing the LCEs by causing them to relax back to the rolled out state.

In an additional embodiment, the light source L2 may illuminate the LCEs via the back instead of via the top, like shown in FIG. 5. In that case the LCEs needs to be positioned in between L2 and a reflector, such that reflected light can reach the photodiode.

This construction is built up on a substrate 2 which in this embodiment also contains an integrated driving electronic 6.

The driving electronic 6, that means a circuit suitable for optical feedback of the state of the LCEs, can be found in FIG. 6. In this circuit the photo-diode acts as a current source whose current depends on the intensity of the incident light from the homogeneous light source L2. For this embodiment we assume that the photodiode is not sensitive to the actuating light produced by L1. When addressed an initial gate-source voltage is stored on the storage capacitor C. If the LCEs are closed then this full voltage will be applied to the gate of the drive transistor and L1 will be of full intensity. When the LCEs start to open, i.e. to roll up or wrap up, then the photo-diode detects a signal from L2 and starts to conduct current. This leads to a current flow which reduces the voltage on the drive transistor and thus the intensity of L1 is reduced.

In this embodiment two extra switches are integrated into the circuit. The circuit layout can be seen in FIG. 7. These are necessary to isolate the photodiode during the period that the structures are being addressed with L1. First the memory capacitance is charged via the data and address lines to the voltage, V, required to produce the necessary light from L1 to modulate the LCEs. S1 is now closed while S2 is left open. If this is the first cycle then the LCEs will be closed and no light from L2 will be incident on the photodiode and nothing will happen. After a period of time S1 is now opened and S2 is closed. This will produce light from L1 and the LCEs will open. The pixel is then re-addressed and C is charged to voltage V again. With S2 opened S1 is closed and depending on the incident light from L2 through the LCEs the photo-diode will discharge to an extent. S1 is then opened and S2 is closed. This is repeated over and over again until the LCEs are sufficiently open to allow just enough light passing through to the photodiode that V is discharged from C and subsequently L1 is not turned on.

### Position Numbers

1 Micro-actuator, means the photosensitive actuator element
2. Substrate
3. Light source, (illumination device)
4. OLED, (illumination device)
5. Photodiode
6. Driving electronics
7. Light shutter means
L1 transparent OLED, (illumination device)
L2 homogeneous light source, (illumination device)
TA, TD Transistors
C Capacitor
S1, S2 Switches

1. A micro-actuator device for the use in a biochip or biosystem, wherein the micro actuator consists of a photosensitive actuator element (1), which can be deformed from a reversal basic-form into an activated deformation form by photonic activation of a light source (3, 4, L1, L2) in order to generate with this controlled movement a defined flow in a gas or a liquid.

2. A micro-actuator device according to claim 1, characterized in that the dynamic parameters of the generated movement is influenced by steering the photonic energy input to the photosensitive actuator element (1) by an illumination device.

3. A micro-actuator device, according to claim 1, characterized in that the photosensitive actuator element (1) is constituted in that way, that the reversal basic form or ground form is an at least partially curled strip, and the deformed form is the at least flattened form of the strip.

4. A micro-actuator device according to claim 3, characterized in that a 2-dimensional matrix array of photosensitive actuator element (1) is arranged on a 2-dimensional photonic processing array of light sources, in which each single illumination device (3, 4, L1, L2) can be steered independently from each other, in order to be able to activate each single photosensitive actuator element (1).

5. A micro-actuator device according to claim 1, characterized in that the material of the photosensitive actuator element (1) is a liquid-crystal-elastomer LCE.

6. A micro-actuator device, according to claim 1, characterized in that the light source is a light emitting diode (4, L1) , and in case of a photonic processing area it is an array of light emitting diodes.

7. A micro-actuator device according to claim 6, characterized in that the light source is, or the light sources respectively is/are organic light emitting diode(s).

8. A micro-actuator device according to claim 1, characterized in that between the light source (4, L1) and the photosensitive actuator element (1) a light shutter means (7) is arranged.

9. A micro-actuator device according to claim 1, characterized in that the light shutter means (7) consists substantially but not exclusively of an Liquid crystal device, by which areas of no light transmission can easily be switched on or off, in order to steer the amount of light energy to the photosensitive actuator element (1).

10. A micro-actuator device according to claim 1, characterized in that between the photosensitive actuator element (1) and the light source secondary polymer-MEMs actuators as light shutters, are arranged which can be activated by heat or electrostatically.

11. A micro-actuator device according to claim 9, characterized in that the light shutter means (7) are arranged as a passive matrix array, or as an active matrix array.

12. A micro-actuator device according to claim 1, characterized in that that the light source is a scanning laser beam.

13. A micro-actuator device according to claim 1, characterized in that two light sources are arranged, one on each side of the actuator in order to control or feedback the mechanical function of the actuator by a camera CCD array or by a photodiode array.

14. A micro-actuator device according to claim 13, characterized in that a circuit to steer the actuator array has integrated a photodiode (L1) as a current source whose current depends on the intensity of an incident light source, by which the optical feedback of the actuator is caused.

15. A micro-actuator device according to claim 14, characterized in that two switches are arranged in the circuit in order to switch between the light source (L1) for photonic actuation of the actuator and the light source (L2) for the optical feedback of the position or actuation of the actuators.
